(19) United States
(12) Patent Application Publication
(10) Pub. No.: US 2020/0162768 A1
(43) Pub. Date: May 21, 2020

(54) APPARATUS AND METHOD OF PROVIDING BROADCASTING SERVICES SIMULTANEOUSLY

(71) Applicant: ELECTRONICS AND TELECOMMUNICATIONS RESEARCH INSTITUTE, Daejeon (KR)

(72) Inventors: Sukhee CHO, Daejeon (KR); ByungJun BAE, Daejeon (KR); DongKwan LEE, Seoul (KR); Heung Mook KIM, Daejeon (KR); Sungheun OH, Seoul (KR)

(21) Appl. No.: 16/691,451

(22) Filed: Nov. 21, 2019

(30) Foreign Application Priority Data
Nov. 21, 2018 (KR) 10-2018-0144902
Oct. 15, 2019 (KR) 10-2019-0127494

(51) Int. Cl. H04N 21/2362; H04N 21/2343; H04N 21/434; H04N 21/4402; H04N 21/414; H04N 21/442

(52) U.S. Cl. CPC H04N 21/2362; H04N 21/23439; H04N 21/442; H04N 21/44029; H04N 21/41415; H04N 21/4345

(57) ABSTRACT

An apparatus for providing broadcasting services simultaneously configures two or more duplicate broadcasting services to be transmitted simultaneously for broadcasting programs of the same contents, generates a Service List Table (SLT) for the two or more broadcasting services, and transmits the two or more broadcasting services together with the SLT information, and the SLT includes duplicate service separator information indicating whether the two or more broadcasting services are being simultaneously broadcasted, and information indicating which one between the two or more duplicate broadcasting services is the service for a fixed TV or the service for a mobile terminal.

### CROSS-REFERENCE TO RELATED APPLICATION

This application claims priority to and the benefit of Korean Patent Application No. 10-2018-0144902 filed in the Korean Intellectual Property Office on Nov. 21, 2018, and Korean Patent Application No. 10-2019-0127494 filed in the Korean Intellectual Property Office on Oct. 15, 2019, the entire contents of which are incorporated herein by reference.

### BACKGROUND OF THE INVENTION

### (a) Field of the Invention

The present invention relates to an apparatus and a method of providing broadcasting services simultaneously, and more particularly, to an apparatus and a method of providing broadcasting services simultaneously, which when two or more broadcasting services are simultaneously provided for the same program by differentiating video resolution and quality, display an appropriate broadcasting service between the broadcasting service for a fixed reception type and the broadcasting service for a mobile reception type on a screen according to a reception situation of a viewer.

### (b) Description of the Related Art

The domestic “terrestrial Ultra High Definition Television (UHDTV) broadcast transmission and reception matching” standard was established based on Advanced Television Systems Committee (ATSC) 3.0 technology that is the next-generation terrestrial broadcasting standard in the United States, and the world's first UHDTV broadcasting service is provided in Korea based on the standard, and new requirements are being derived according to the UHDTV broadcasting service model.

Although broadcasts are being conducted in Korea, but currently, broadcast terminals include not only fixed TVs having large screens fixed at home, but also mobile terminals, such as a tablet PC or a smart phone, with small screens, which are generalized. Accordingly, broadcasting business operators may want to provide programs of the same contents in two forms of UHD and HD media in one channel for users of mobile terminals, as well as a fixed TV. When the broadcasting service in the foregoing form is realized, a fixed TV or a mobile terminal displays programs of the same contents in two channels for UHD and HD media. Despite the presence of a high-quality UHD broadcasting program channel, the fixed TV provides an environment in which viewers make the mistake of watching low-quality HD media. Further, the mobile terminal displays the UHD broadcasting program channel, but fails to properly receive a large UHD signal according to a network situation, so that there may occur a problem in that no media is reproduced on a screen. Accordingly, when the simultaneous broadcastings are performed for the media of the same contents, information that can be processed by a terminal is required so that an appropriate broadcasting program between the broadcasting program for a fixed reception type or the broadcasting program for the mobile reception type is provided to a viewer according to a reception situation of the viewer.

### SUMMARY OF THE INVENTION

The present invention has been made in an effort to provide an apparatus and a method of providing broadcasting services simultaneously, which when the services for the broadcasting programs of the same contents for a fixed reception type and a mobile reception type are provided simultaneously under the terrestrial Ultra High Definition Television (UHDTV) broadcast standard, display an appropriate broadcasting program between the broadcasting program for the fixed reception type or the broadcasting program for the mobile reception type on a screen according to a reception situation of a viewer. An exemplary embodiment of the present invention provides a method of providing, by an apparatus for providing broadcasting services simultaneously, broadcasting services simultaneously through a broadcasting network. The method includes: configuring two or more duplicate broadcasting services to be simultaneously transmitted for broadcasting programs of the same contents; generating a Service List Table (SLT) for the two or more broadcasting services; and transmitting the two or more broadcasting services together with the SLT information, in which the SLT includes duplicate service separator information indicating whether the two or more broadcasting services are being simultaneously broadcasted, and information indicating which one between the two or more duplicate broadcasting services is the service for a fixed TV or the service or a mobile terminal.

The duplicate service separator information may include at least one of information indicating whether the broadcasting program has the duplicate services, the number of duplicate services for the broadcasting program, a broadcast stream identifier for the duplicate service, and an identifier for the duplicate service.

The information indicating whether the duplicate broadcasting service is the service for the fixed TV or the service for the mobile terminal may include a target reception type value for the corresponding broadcasting service.

The target reception type value for the corresponding broadcasting service may be provided through a capability code value.

Another exemplary embodiment of the present invention provides an apparatus for providing broadcasting services simultaneously, which provides two or more broadcasting services for the same broadcasting program simultaneously through a broadcasting network. The apparatus includes: a processor configured to configure two or more broadcasting services for the same broadcasting program, and generate a Service List Table (SLT) for the two or more broadcasting services; and a transceiver configured to transmit the two or more broadcasting services together with the SLT information through a broadcasting network, in which the SLT includes duplicate service separator information indicating whether the two or more broadcasting services are being simultaneously broadcasted, and reception type information about the two or more duplicate broadcasting services.

The processor may provide the reception type information through a reception type value defined according to whether a reception type is a fixed TV or a mobile terminal.

The processor may provide the reception type information through a capability code value defined according to whether a reception type is a fixed TV or a mobile terminal.

The duplicate service separator information may include at least one of information indicating whether the broadcasting program has the duplicate services, the number of duplicate services for the broadcasting program, a broadcast stream identifier for the duplicate service, and an identifier for the duplicate service.

Another exemplary embodiment of the present invention provides a method of receiving, by an apparatus for receiving a broadcasting service, two or more duplicate broadcasting services transmitted simultaneously through a broadcasting network. The method includes: receiving a Service List Table (SLT) for each broadcasting service; parsing the SLT for each broadcasting service and checking whether the received broadcasting services are being simultaneously broadcasted in duplicate; when the broadcasting services are being simultaneously broadcasted in duplicate, checking reception type information about the corresponding broadcasting service within the SLT for each broadcasting service; and displaying one broadcasting service appropriate to the apparatus for receiving the broadcasting service between the two or more duplicate broadcasting services by using the reception type information.

The SLT may include duplicate service separator information indicating whether the two or more broadcasting services are being simultaneously broadcasted, and reception type information about the two or more duplicate broadcasting services.

The checking of the reception type information about the corresponding broadcasting service may include checking the reception type information through a reception type value defined according to whether a reception type of the corresponding broadcasting service is a fixed TV or a mobile terminal.

The checking of the reception type information about the corresponding broadcasting service may include checking the reception type information through a capability code value defined according to whether a reception type of the corresponding broadcasting service is a fixed TV or a mobile terminal.

### BRIEF DESCRIPTION OF THE DRAWINGS

FIG. 1 is a conceptual diagram of simultaneous broadcasting services for a fixed reception type and a mobile reception type in a terrestrial Ultra High Definition Television (UHDTV) broadcast according to an exemplary embodiment of the present invention.

FIG. 2 is a diagram illustrating a Service List Table (SLT) defined in the terrestrial UHDTV broadcast standard according to the exemplary embodiment of the present invention.

FIG. 3 is a diagram illustrating an SLT providing an Advanced Television Systems Committee (ATSC) 3.0 duplicate service separator according to the exemplary embodiment of the present invention.

FIG. 4 is a diagram illustrating an SLT providing an ATSC 3.0 duplicate service separator according to another exemplary embodiment of the present invention.

FIG. 5 is a diagram illustrating a code value of serviceReceptionType illustrated in FIG. 4.

FIG. 6 is a diagram illustrating an SLT providing an ATSC 3.0 duplicate service separator using capability information of a service according to another exemplary embodiment of the present invention.

FIG. 7 is a diagram illustrating a capability code value defined in an existing SLT.

FIG. 8 is a diagram illustrating a capability code value in which a reception type is defined according to the exemplary embodiment of the present invention.

FIG. 9 is a flowchart illustrating a method of providing broadcasting services simultaneously according to an exemplary embodiment of the present invention.

FIG. 10 is a diagram illustrating a method of receiving a broadcasting service according to an exemplary embodiment of the present invention.

FIG. 11 is a diagram illustrating an apparatus for providing broadcasting services simultaneously according to an exemplary embodiment of the present invention.

FIG. 12 is a diagram illustrating an apparatus for receiving a broadcasting service according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and the claims, unless explicitly described to the contrary, the word “comprise” and variations such as “comprises” or “comprising”, will be understood to imply the inclusion of stated elements but not the exclusion of any other elements.

Hereinafter, an apparatus and a method of providing broadcasting services simultaneously according to an exemplary embodiment of the present invention will be described in detail with reference to the drawings.

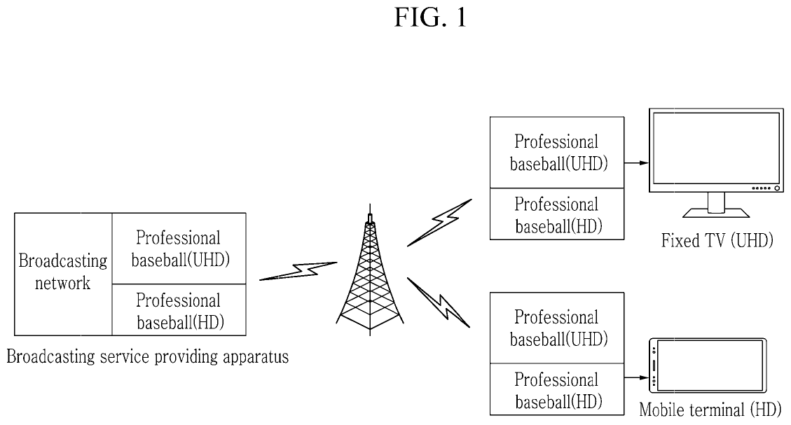

FIG. 1 is a conceptual diagram of simultaneous broadcasting services for a fixed reception type and a mobile reception type in a terrestrial Ultra High Definition Television (UHDTV) broadcast according to an exemplary embodiment of the present invention.

Referring to FIG. 1, an apparatus for providing broadcasting services simultaneously may provide two or more broadcasting services providing the same program with different video resolutions or qualities within one channel through a broadcast network. For example, the apparatus for providing broadcasting services simultaneously may have a service which provides the same programs (professional baseball) with UHD resolution and HD resolution simultaneously, and enable a viewer of a fixed TV receiver to watch the program of the UHDTV quality and a viewer of a mobile terminal to watch the program of the HDTV quality.

In the terrestrial UHDTV broadcast standard, a Service List Table (SLT0 provides signaling information on a service list informing the kind of a current broadcasted program. Accordingly, in the exemplary embodiment of the present invention, when the services for broadcasting programs of the same contents for a fixed reception type and a mobile reception type are provided simultaneously based on the Advanced Television Systems Committee (ATSC) 3.0, the present invention aims to solve redundancy between the ATSC 3.0 services by adding the information indicating that the program is being broadcasted simultaneously in duplicate to the SLT.

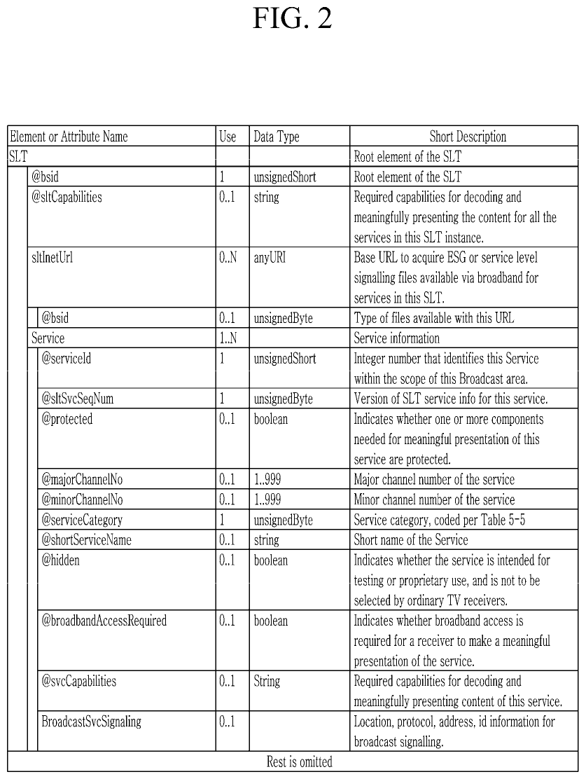

Currently, in the terrestrial UHDTV broadcast standard conforming to the ATSC 3.0, the SLT is defined as illustrated in FIG. 2.

FIG. 2 is a diagram illustrating an SLT defined in the terrestrial UHDTV broadcast standard according to the exemplary embodiment of the present invention.

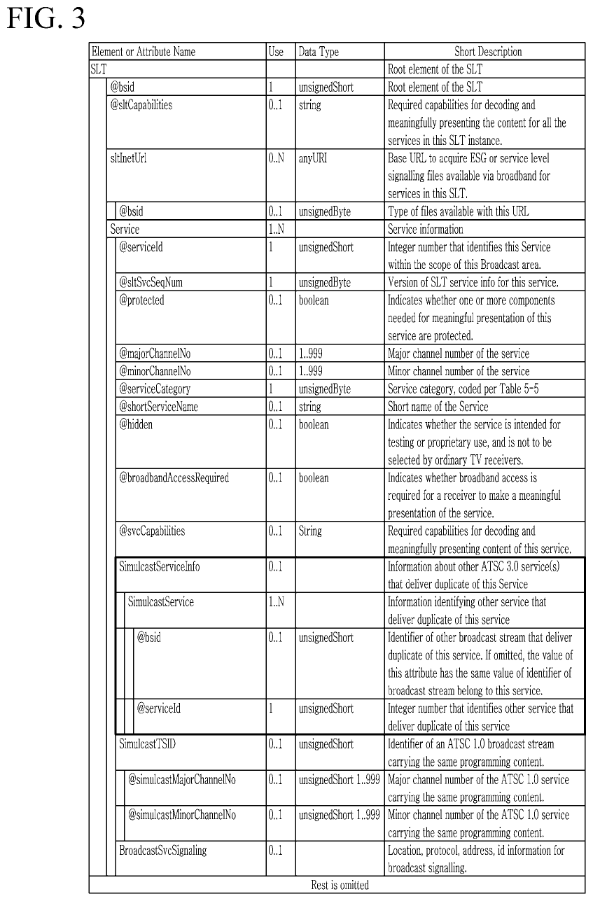

Referring to FIG. 2, the SLT does not provide information on other services corresponding to the simultaneous broadcasting in each service. Accordingly, in the exemplary embodiment of the present invention, as illustrated in FIG. 3, information indicating that broadcasting programs of the same content are broadcasted simultaneously in duplicate is additionally defined in the existing SLT.

FIG. 3 is a diagram illustrating an SLT providing an Advanced Television Systems Committee (ATSC) 3.0 duplicate service separator according to the exemplary embodiment of the present invention.

Referring to FIG. 3, when the apparatus for providing broadcasting services simultaneously simultaneously provides the services for broadcast programs of the same contents for a fixed reception type and a mobile reception type, duplicate service separator information (SimulcastServiceInfo, SimulcastService, @bsid, and @serviceid) indicating that the corresponding program is simultaneously broadcasted in duplicate is additionally defined in the existing SLT. SimulcastServiceInfo indicates other ATSC 3.0 services that deliver the corresponding service in duplicate. SimulcastService indicates the number of ATSC 3.0 services that deliver the corresponding service in duplicate. @bsid indicates a Broadcast Stream Identifier (BSID) for the duplicate ATSC 3.0 services. When the duplicate ATSC 3.0 services belong to the same broadcast stream, the attribute may not be used. @serviceid indicates an identifier for the duplicate ATSC 3.0 services.

A receiving apparatus may recognize whether the corresponding service is simultaneously broadcasted in duplicate by SLT parsing, the number of services that are being simultaneously broadcasted in duplicate, and the corresponding broadcast stream identifier and service identifier.

As described above, the method of adding the information indicating that the broadcast programs of the same contents are being simultaneously broadcasted in duplicate to the existing SLT provides only information indicating whether there is the duplicate services based on the ATSC 3.0 for the corresponding service, and a corresponding BSID and information about the service are provided when there are the duplicate services in the SLT. Accordingly, the receiving device has two or more duplicate services, but cannot recognize which service among the duplicate services is a service for a fixed TV or a service for a mobile terminal, and may predict and process the duplicate process by information, such as media resolution or a bit rate, of the corresponding service received after the SLT.

In another exemplary embodiment of the present invention, a method of adding information indicating whether the duplicate service is a service for a fixed TV or a service for a mobile terminal to the SLT together with the previously suggested signaling information is suggested.

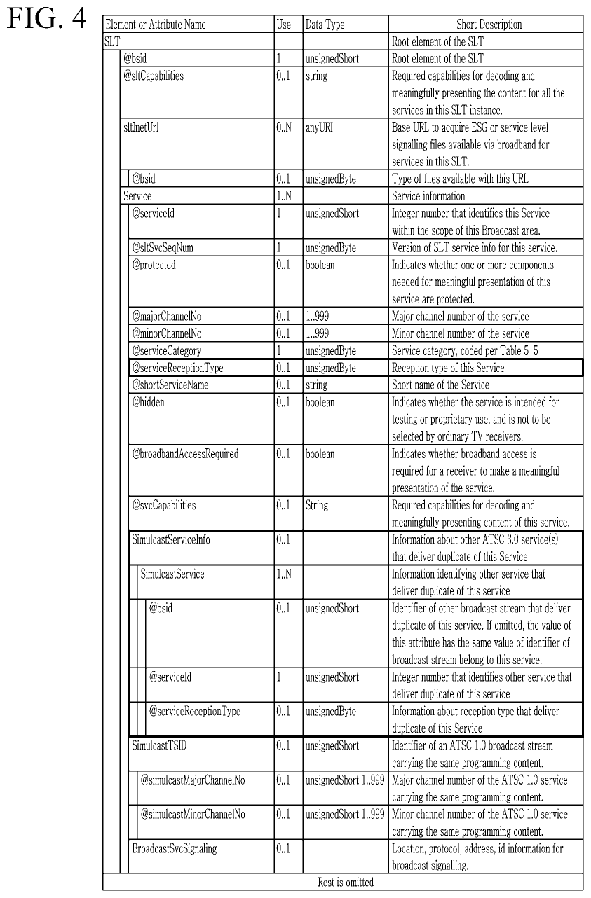

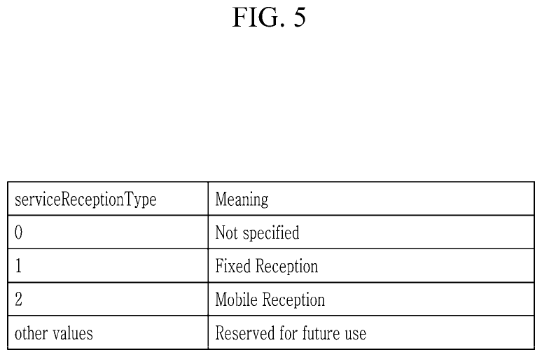

FIG. 4 is a diagram illustrating an SLT providing an ATSC 3.0 duplicate service separator according to another exemplary embodiment of the present invention, and FIG. 5 is a diagram illustrating a code value of serviceReceptionType illustrated in FIG. 4.

As illustrated in FIG. 4, the apparatus for providing broadcasting services simultaneously further includes reception type information (@serviceReceptionType) in the existing SLT as duplicate service information. The reception type information indicates information indicating which one between two or more duplicate services is a service for a fixed TV or a service or a mobile terminal in the form of the reception.

The reception type information (@serviceReceptionType) included in the service item indicates reception type information about the service. Further, when there are the duplicate services for the same program as that of the service (serviceid), the reception type information for the duplicate services is displayed in the reception type information (@serviceReceptionType) included in the duplicate service (SimulcastService) item.

The reception type information (@serviceReceptionType) indicates a target reception type of the corresponding service, and a value of the reception type information (@serviceReceptionType) is defined as illustrated in FIG. 5.

For example, when the service (serviced) is a UHD video service for a fixed TV as a target reception, the apparatus for providing the broadcasting services simultaneously displays information indicating the fixed TV in the reception type information (@serviceReceptionType) included in the service item. When the apparatus for providing the broadcasting services simultaneously provides a video service for the same program as that of the service (serviceId) to a mobile terminal in duplicate, the apparatus for providing the broadcasting service simultaneously provides duplicate service information, and in this case, the apparatus for providing the broadcasting service displays information indicating the mobile terminal in the reception type information (@serviceReceptionType) included in the duplicate service (SimulcastService) item.

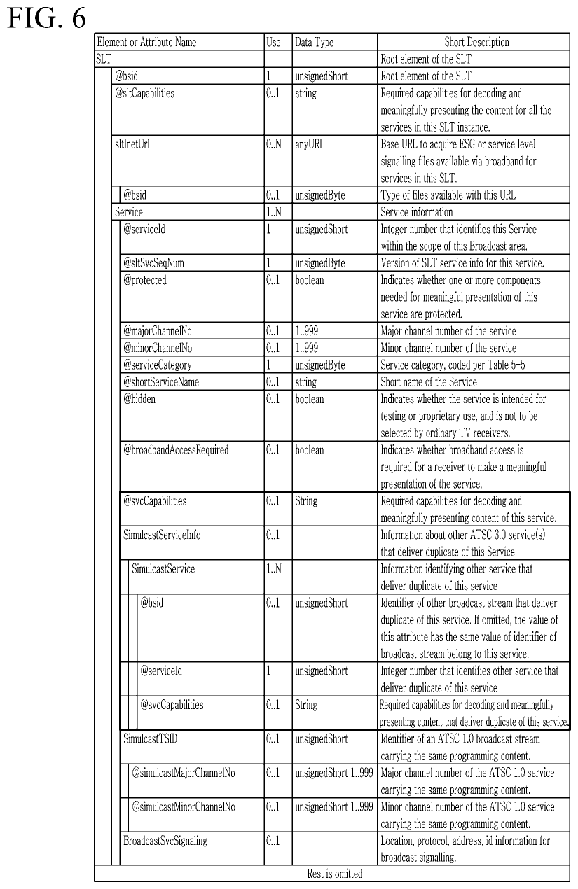

FIG. 6 is a diagram illustrating an SLT providing an ATSC 3.0 duplicate service separator using capability information of a service according to another exemplary embodiment of the present invention.

Referring to FIG. 6, the apparatus for providing the broadcasting services simultaneously may inform information indicating whether the service is the service for the fixed TV or the service for the mobile terminal in the form of capability information (@svcCapabilities) required for contents decoding or a meaningful expression of the corresponding service in the existing SLT.

The apparatus for providing the broadcasting services simultaneously additionally defines the duplicate service separator information (SimulcastServiceInfo, SimulcastService, @bsid, @serviceid) and capability information (@svcCapabilities) in the existing SLT. The capability information (@svcCapabilities) provides a capability code value indicating a reception type of the duplicate ATSC 3.0 services.

As described above, the capability information (@svcCapabilities) included in the service (service) item may indicate the reception type information about the service (serviceId). Further, when there are the duplicate services for the same program as that of the service (serviceid), the reception type information for the duplicate services (SimulcastService) may be displayed in the capability information (@svcCapabilities) item included in the duplicate service (SimulcastService) item.

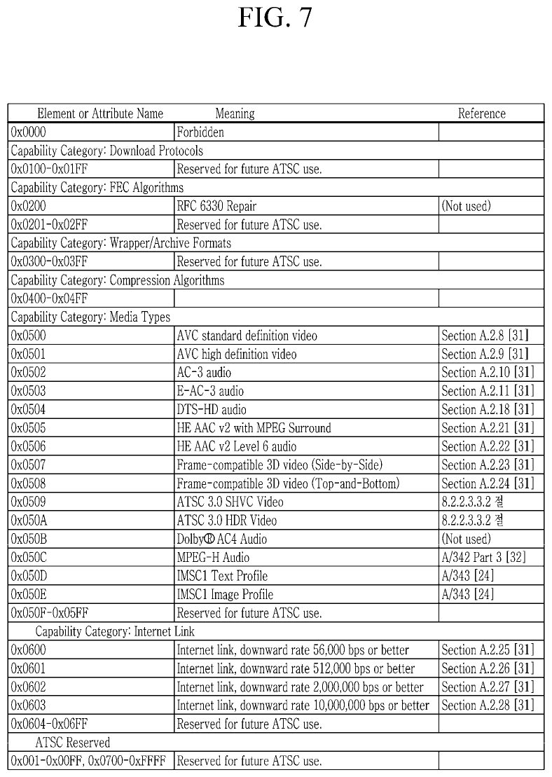

A value of the capability information (@svcCapabilities) defined in the current SLT is defined as illustrated in FIG. 7.

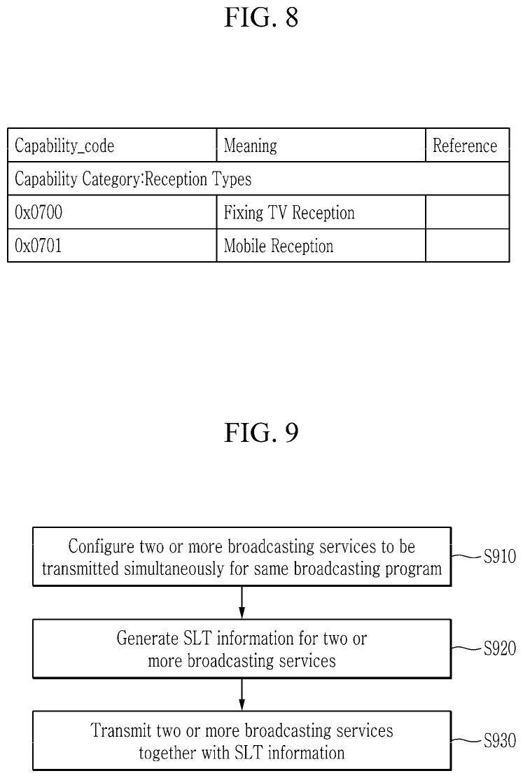

FIG. 7 is a diagram illustrating a performance code value defined in the existing SLT, and FIG. 8 is a diagram illustrating a capability code value in which a reception type is defined according to the exemplary embodiment of the present invention.

Referring to FIG. 7, the capability code value in the existing SLT is classified into six categories, such as Download Protocols, FEC Algorithms, Wrapper/Archive Formats, Compression Algorithms, Media Types, and Internet Link, and is defined.

In the exemplary embodiment of the present invention, as illustrated in FIG. 8, as the capability code value, a category of the reception type is newly defined, and a capability code value according to the reception type is defined.

The apparatus for providing the broadcasting services simultaneously defines the reception type information about the corresponding service in the performance code value “reserved” for the future ATSC use as illustrated in FIG. 7, to enable a user to know whether the service is the service for the fixed TV or the service for the mobile terminal.

That is, a user may know whether the service is the service for a fixed TV or the service for the mobile terminal by the capability code value defined with the reception type. For example, when the capability code value is “0×0700”, this may indicate that the reception type of the corresponding service is a fixed TV, and when the capability code value is “0×0701”, this may indicate that the reception type of the corresponding service is a mobile terminal.

FIG. 9 is a flowchart illustrating a method of providing broadcasting services simultaneously according to an exemplary embodiment of the present invention.

Referring to FIG. 9, the apparatus for providing the broadcasting services simultaneously configures two or more broadcasting services by differentiating resolution or quality in order to simultaneously provide the services for broadcasting programs of the same contents for a fixed reception type and a mobile reception type (S910). For example, the apparatus for providing the broadcasting services simultaneously may configure broadcasting programs of the same contents in the form of a broadcasting service of UHD resolution and HD resolution.

The apparatus for providing the broadcasting services simultaneously generates SLT information for two or more broadcasting services to be transmitted simultaneously through a broadcasting network (S920). In this case, the apparatus for providing the broadcasting services simultaneously includes information indicating that two or more broadcasting services are being broadcasted simultaneously and information indicating that the simultaneously provided broadcasting services are the service for the fixed TV or the service for the mobile terminal in the existing SLT.

The apparatus for providing the broadcasting services simultaneously transmits two or more broadcasting services simultaneously through the broadcasting network together with the SLT information (S930).

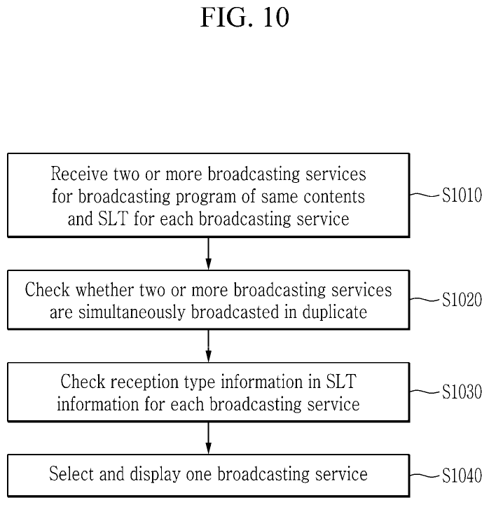

FIG. 10 is a diagram illustrating a method of receiving a broadcasting service according to an exemplary embodiment of the present invention.

Referring to FIG. 10, an apparatus for receiving a broadcasting service receives two or more broadcasting services for broadcasting programs of the same contents and SLT information about each broadcasting service (S1010).

The apparatus for receiving the broadcasting service parses the received SLT information about each broadcasting service and checks whether the received broadcasting service is simultaneously broadcasted in duplicate (S1020).

When the corresponding broadcasting services are simultaneously broadcasted in duplicate, the apparatus for receiving the broadcasting service checks reception type information within the SLT information about each broadcasting service (S1030), and selects one broadcasting service appropriate to the apparatus for receiving the broadcasting service between two or more duplicate broadcasting services by using the reception type information and displays the selected broadcasting service (S1040).

As described above, even though the simultaneous broadcasting services for the broadcasting programs of the same contents are provided for the fixed TV and the mobile terminal, the apparatus for receiving the broadcasting service may select an appropriate broadcasting service according to a reception situation of the apparatus for receiving the broadcasting service through the reception type information within the SLT information.

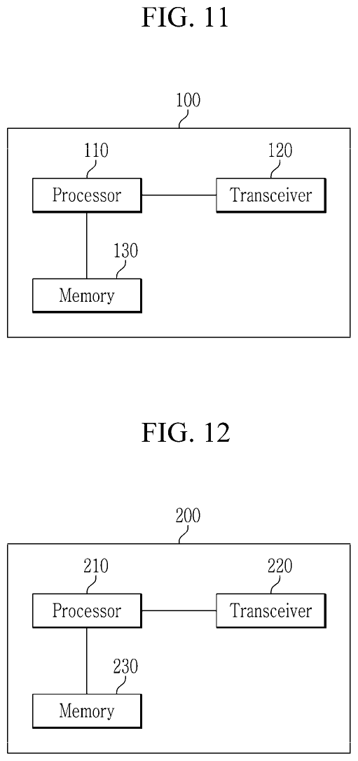

FIG. 11 is a diagram illustrating the apparatus for providing the broadcasting services simultaneously according to the exemplary embodiment of the present invention.

Referring to FIG. 11, the apparatus 100 for providing the broadcasting services simultaneously includes a processor 110, a transceiver 120, and a memory 130.

The processor 110 provides two or more broadcasting services for the same broadcasting program simultaneously by differentiating video resolution or quality within one channel. Further, the processor 110 adds information indicating that the corresponding programs are being simultaneously broadcasted in duplicate to the SLT to enable a receiver to receive an appropriate broadcasting service between the broadcasting service for a fixed reception type and the broadcasting service for a mobile reception type according to a reception situation. As described with reference to FIGS. 3, 4, 5, 6, and 8, the processor 110 adds information indicating that the broadcasting programs of the same contents are being simultaneously broadcasted in duplicate to the existing SLT, and informs whether the corresponding broadcasting program is the service for a fixed TV or a service for a mobile terminal. The processor 110 may implement the operations and the functions of the apparatus for providing the broadcasting services simultaneously described with reference to FIGS. 3, 4, 5, 6, and 8 by executing instructions stored in or loaded to the memory 130. The processor 110 may mean a Central Processing Unit (CPU), a Graphics Processing Unit (GPU), or an exclusive processor by which the methods according to the exemplary embodiment of the present invention are performed.

The transceiver 120 is connected with the processor 110 to transmit two or more broadcasting services and a broadcasting signal including the SLT.

The memory 130 is connected with the processor 110 to store various information for driving the processor 110. The memory 130 may have stored instructions executed by the processor 110, or load instructions from a storage device (not illustrated) and temporarily store the loaded instructions. The memory 230 may include a Read-Only Memory (ROM), a Random Access Memory (RAM), a flash memory, a memory card, a storage medium, and/or other storage devices.

FIG. 12 is a diagram illustrating the apparatus for receiving the broadcasting service according to the exemplary embodiment of the present invention.

Referring to FIG. 12, the apparatus 200 for receiving the broadcasting service includes the processor 210, a transceiver 220, and a memory 230.

When the processor 210 receives two or more broadcasting services for the same broadcasting program within one channel and an SLT for the broadcasting services, the processor 210 parses the SLT to check that the broadcasting programs of the same contents are simultaneously broadcasted in duplicate, and selects an appropriate broadcasting service according to a reception situation of the apparatus 200 for receiving the broadcasting service based on reception type information of each broadcasting service in the SLT and provides the selected broadcasting service as described with reference to FIG. 10. The processor 210 may implement the operations and the functions of the apparatus for receiving the broadcasting service described with reference to FIG. 10 by executing instructions stored in or loaded to the memory 230. The processor 210 may mean a CPU, a GPU, or an exclusive processor by which the methods according to the exemplary embodiment of the present invention are performed.

The transceiver 220 is connected with the processor 210 to receive two or more broadcasting services and a broadcasting signal including the SLT.

The memory 230 is connected with the processor 210 to store various information for driving the processor 210. The memory 230 may have stored instructions executed by the processor 210, or load instructions from a storage device (not illustrated) and temporarily store the loaded instructions. The memory 230 may include a ROM, a RAM, a flash memory, a memory card, a storage medium, and/or other storage devices.

According to the exemplary embodiment of the present invention, when the services for broadcasting programs of the same contents for a fixed reception type and a mobile reception type are provided simultaneously under the terrestrial Ultra High Definition Television (UHDTV) broadcast standard, information indicating that the corresponding programs are being simultaneously broadcasted in duplicate is provided, so that a reception apparatus may display an appropriate broadcasting program between the broadcasting program for the fixed reception type and the broadcasting program for the mobile reception type on a screen according to a reception situation by using the information. That is, it is possible to simultaneously provide the service for the same broadcasting program to a fixed TV and a mobile terminal without causing confusion to a viewer.

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

What is claimed is:

1. A method of providing, by an apparatus for providing broadcasting services simultaneously, broadcasting services simultaneously through a broadcasting network, the method comprising:
configuring two or more duplicate broadcasting services to be simultaneously transmitted for broadcasting programs of the same contents;
generating a Service List Table (SLT) for the two or more broadcasting services; and
transmitting the two or more broadcasting services together with the SLT information,
wherein the SLT includes duplicate service separator information indicating whether the two or more broadcasting services are being simultaneously broadcasted, and information indicating which one between the two or more duplicate broadcasting services is the service for a fixed TV or the service or a mobile terminal.

2. The method of claim 1, wherein:
the duplicate service separator information includes at least one of information indicating whether the broadcasting program has the duplicate services, the number of duplicate services for the broadcasting program, a broadcast stream identifier for the duplicate service, and an identifier for the duplicate service.

3. The method of claim 1, wherein:
the information indicating whether the duplicate broadcasting service is the service for the fixed TV or the service for the mobile terminal includes a target reception type value for the corresponding broadcasting service.

4. The method of claim 1, wherein:
the target reception type value for the corresponding broadcasting service is provided through a capability code value.

5. The method of claim 4, wherein:
the capability code value according to a reception type is defined as a capability category.

6. An apparatus for providing broadcasting services simultaneously, which provides two or more broadcasting services for the same broadcasting program simultaneously through a broadcasting network, the apparatus comprising:
a processor configured to configure two or more broadcasting services for the same broadcasting program, and generate a Service List Table (SLT) for the two or more broadcasting services; and
a transceiver configured to transmit the two or more broadcasting services together with the SLT information through a broadcasting network,
wherein the SLT includes duplicate service separator information indicating whether the two or more broadcasting services are being simultaneously broadcasted, and reception type information about the two or more duplicate broadcasting services.

7. The apparatus of claim 6, wherein:
the processor provides the reception type information through a reception type value defined according to whether a reception type is a fixed TV or a mobile terminal.

8. The apparatus of claim 6, wherein:
the processor provides the reception type information through a capability code value defined according to whether a reception type is a fixed TV or a mobile terminal.

9. The apparatus of claim 6, wherein:
the duplicate service separator information includes at least one of information indicating whether the broadcasting program has the duplicate services, the number of duplicate services for the broadcasting program, a broadcast stream identifier for the duplicate service, and an identifier for the duplicate service.

10. A method of receiving, by an apparatus for receiving a broadcasting service, two or more duplicate broadcasting services transmitted simultaneously through a broadcasting network, the method comprising:
receiving a Service List Table (SLT) for each broadcasting service,
parsing the SLT for each broadcasting service and checking whether the received broadcasting services are being simultaneously broadcasted in duplicate;
when the broadcasting services are being simultaneously broadcasted in duplicate, checking reception type information about the corresponding broadcasting service within the SLT for each broadcasting service; and
displaying one broadcasting service appropriate to the apparatus for receiving the broadcasting service between the two or more duplicate broadcasting services by using the reception type information.

11. The method of claim 10, wherein:
the SLT includes duplicate service separator information indicating whether the two or more broadcasting services are being simultaneously broadcasted, and reception type information about the two or more duplicate broadcasting services.

12. The method of claim 10, wherein:
the checking of the reception type information about the corresponding broadcasting service includes checking the reception type information through a reception type value defined according to whether a reception type of the corresponding broadcasting service is a fixed TV or a mobile terminal.

13. The method of claim 10, wherein:
the checking of the reception type information about the corresponding broadcasting service includes checking the reception type information through a capability code value defined according to whether a reception type of the corresponding broadcasting service is a fixed TV or a mobile terminal.
